(19) United States
(12) Patent Application Publication
(10) Pub. No.: US 2010/0118760 A1
(43) Pub. Date: May 13, 2010

(54) METHOD FOR TRANSMITTING MOBILE MULTIMEDIA BROADCAST SERVICE DATA FLOW AND A MULTIPLEXING FRAME FOR TRANSMITTING

(75) Inventors: Daxiong Xie, Guangdong (CN); Xiangbiao Yan, Guangdong (CN); Biao Wang, Guangdong (CN); Yuanli Fang, Guangdong (CN); Jianqiang Zhang, Guangdong (CN)

Correspondence Address: BROOKS KUSHMAN P.C., 1000 TOWN CENTER, TWENTY-SECOND FLOOR, SOUTHFIELD, MI, 48075, US

(73) Assignee: ZTE CORPORATION, Shenzhen City, Guangdong (CN)

(21) Appl. No.: 12/668,246

(22) PCT Filed: May 4, 2008
(86) PCT No.: PCT/CN2008/070872

§ 371 Date: Jan. 8, 2010

(30) Foreign Application Priority Data
Jul. 11, 2007 (CN) 200710126087.7

(51) Int. Cl. H04H 20/71

(52) U.S. Cl. 370/312

(57) ABSTRACT

The present invention discloses a method for transmitting mobile multimedia broadcast service data flow and a multiplex-frame for transmitting to improve transmission efficiency and fault tolerance of a multimedia broadcast system. The method comprises: using, by a transmitter, one or more multiplexing blocks to carry a service data packet of a mobile multimedia broadcast system, encapsulating the one or more multiplexing blocks as load into a video, audio or data unit of a mobile multimedia broadcast standard multiplex-frame corresponding to the service data packet, then encapsulating the video, audio or data unit into a multiplex sub-frame, and assembling a plurality of multiplex sub-frames into a multiplex-frame and sending it via a mobile multimedia broadcast network; receiving, by a receiver; and utilizing, by a terminal, the service data packet obtained by resolving the multiplexing blocks to realize upper layer application.

### TECHNICAL FIELD

The invention relates to the field of a mobile multimedia broadcast service technology, and more particularly, to a method for transmitting mobile multimedia broadcast service data flow and a multiplex-frame for transmitting.

### TECHNICAL BACKGROUND

Mobile multimedia broadcast is a broadcasting-mode multimedia playing technology emerging in recent years. Multimedia services such as TV and the like may be viewed through a handheld terminal in the case of high speed moving. The terminal may receive a program list for multimedia services via a wireless broadcast channel, select frequency channels which is entitled to watch, and receive multimedia data of the selected frequency channels, thus watching TV on the mobile terminal is realized.

At present, a variety of data transmission methods, such as, commonly, transport stream, multi-protocol encapsulation, IP data encapsulation, etc., may be used in mobile multimedia broadcast systems. In mobile multimedia broadcast systems of China, a structure of a multiplex-frame, which includes payload and a multiplex-frame header composed of length information and media parameters, is the second part of series standards. The multiplex-frame defines an encapsulation format for a data flow. One multiplex-frame is composed of a plurality of multiplex sub-frames, the number of which is contained in the multiplex-frame header.

Content of one multimedia broadcast service is encapsulated in each multiplex sub-frame, which includes a multiplex sub-frame header, a video section, an audio section and a data section, as shown in FIG. 1. As shown in FIG. 2(a), the video section is formed by encapsulating a plurality of video units; as shown in FIG. 2(b), the audio section is formed by encapsulating a plurality of audio units; and as shown in FIG. 2(c), the audio section is formed by encapsulating a plurality of data units.

It can be seen from the above that the video unit, audio unit and data unit are minimal unit used in existing data flow encapsulation methods. When an error occurs in transmitting data, because there is no significant boundary distinction between the video unit, audio unit, data unit and their adjacent unit, data of all of the units of the video/audio/data section are required to be discarded. Thus, there is no way to discard only the units in which an error occurs, resulting in error extension, thereby greatly affecting transmission efficiency and fault tolerance of a multimedia broadcast system.

### SUMMARY OF THE INVENTION

A technical problem to be solved by the present invention is to provide a method for transmitting mobile multimedia broadcast service data flow and a multiplex-frame for transmitting to improve transmission efficiency and fault tolerance of a multimedia broadcast system.

The method for transmitting mobile multimedia broadcast service data flow provided by the present invention comprises the following steps of:

carrying a service data packet of a mobile multimedia broadcast system using one or more multiplexing blocks; and

encapsulating the one or more multiplexing blocks as load into a video, audio or data unit of a mobile multimedia broadcast standard multiplex-frame corresponding to the service data packet, then encapsulating the video, audio or data unit into a multiplex sub-frame, and assembling a plurality of multiplex sub-frames into a multiplex-frame and sending it via a mobile multimedia broadcast network.

Further, the multiplexing block comprises the header and the load, wherein the header comprises a start code used for identifying a beginning of the multiplexing block and a position mark used for indicating whether the current multiplexing block is the first multiplexing block or the last multiplexing block of the service data packet.

Further, when a plurality of multiplexing blocks carry the service data packets of the mobile multimedia broadcast system, the position mark is separated into a start mark used for marking the first multiplexing block and an end mark used for marking the last multiplexing block.

Further, the method is particularly used for a service data packet for mobile multimedia broadcast transmitted according to a real time transmission protocol.

The multiplexing block further comprises one or more of the following information: a type of the carried service data representing the type of the service data carried by the multiplexing block, load length information of the multiplexing block representing the length of the load of the multiplexing block, and fault tolerance information, by which a terminal performs fault tolerance and checking for the service data packet carried by the multiplexing block.

In order to solve the technical problem described above, the present invention further provides a method for transmitting mobile multimedia broadcast service data flow, the method comprises the following steps of:

using, by a transmitter, one or more multiplexing blocks to carry a service data packet of a mobile multimedia broadcast system, encapsulating the one or more multiplexing blocks as load into a video, audio or data unit of a mobile multimedia broadcast standard multiplex-frame corresponding to the service data packet, then encapsulating the video, audio or data unit into a multiplex sub-frame, and assembling a plurality of multiplex sub-frames into a multiplex-frame and sending it via a mobile multimedia broadcast network;

receiving, by a receiver, the multiplex-frame from a physical channel and resolving it to obtain video, audio or data units, and resolving the multiplexing blocks in the video, audio or data units to obtain the service data packet; and

utilizing, by a terminal, the service data packet obtained by resolving the multiplexing blocks to realize upper layer application.

In order to solve the technical problem described above, the present invention further provides a multiplex-frame for transmitting mobile multimedia broadcast service data flow, the multiplex-frame is composed of a plurality of multiplex sub-frames, each of which is used for carrying a video, audio or data unit, wherein:

the load of the video, audio or data unit contains one or more multiplexing blocks used to carry a service data packet of a multimedia broadcast system, wherein each multiplexing block comprises the header and the load, the header comprises a start code used for identifying the beginning of the multiplexing block and a position mark used for indicating whether the current multiplexing block is the first multiplexing block or the last multiplexing block of the service data packet.

The present invention presents a method for transmitting mobile multimedia broadcast service data flow in a mobile multimedia broadcast network. In the method, a video, audio or data unit is formed by encapsulating one or more multiplexing blocks, each multiplexing block being isolated by a start code boundary to achieve error isolation. The method allows a plurality of multiplexing blocks to transmit one multimedia service data packet through multiplexing block marks. The method further presents the type of the multiplexing blocks for a structure design of a multiplex-frame of mobile multimedia broadcast to ensure high transmission efficiency and good fault tolerance of the mobile multimedia broadcast system. In addition, in the method, an overhead for the header of the multiplexing block is small, thereby ensuring the performance of multimedia broadcast transmission.

### BRIEF DESCRIPTION OF THE DRAWINGS

FIG. 1 is a structure scheme of a multiplex sub-frame;

FIG. 2(a) is a structure scheme of a video section;

FIG. 2(b) is a structure scheme of an audio section;

FIG. 2(c) is a structure scheme of a data section;

FIG. 3 is a structure scheme of a multiplexing block in one embodiment; and

FIG. 4 is a structure scheme of a multiplexing block in one application example.

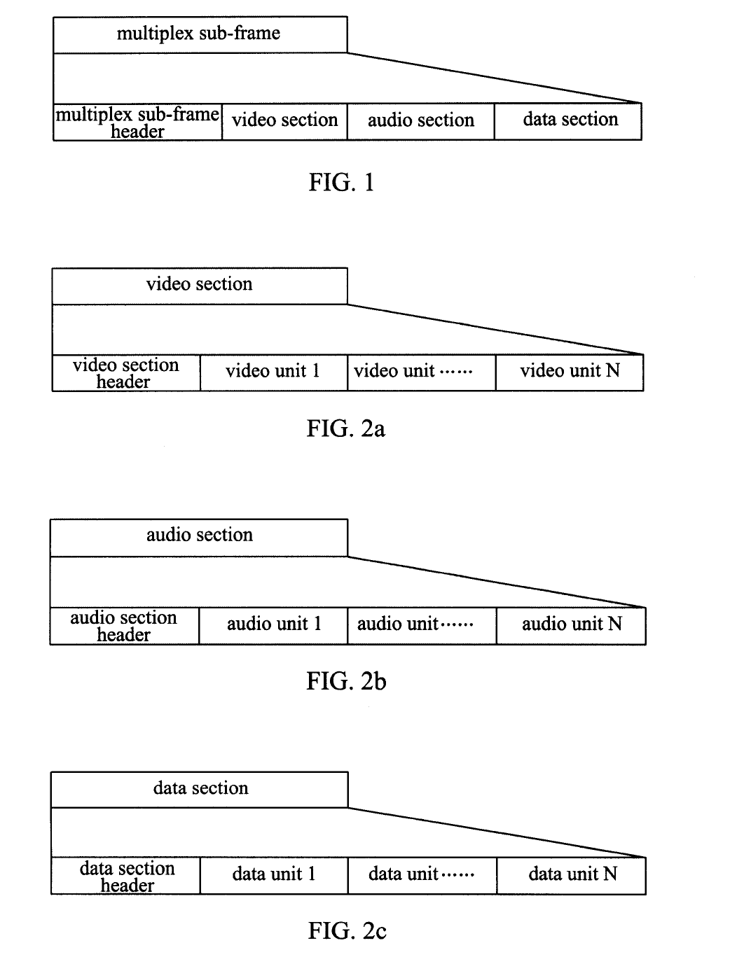

### PREFERRED EMBODIMENTS OF THE INVENTION

The present invention will be further described below in conjunction with the accompany drawings.

The principal conception of the present invention is to use one or more multiplexing blocks to carry a service data packet of a mobile multimedia broadcast system, especially a data packet transmitted according to a real time transmission protocol, each multiplexing block containing at least a start code and a position mark, then encapsulate the one or more multiplexing blocks as the load into a corresponding service data unit, that is, a video, audio or data unit, then encapsulate the service data unit into a multiplex sub-frame with a mobile multimedia broadcast standard multiplex-frame structure, and assemble a plurality of multiplex sub-frames into a multiplex-frame and send it via a mobile multimedia broadcast network.

A method for transmitting mobile multimedia broadcast service data flow in accordance with one embodiment comprises the following steps:

Step 1: a service data packet carried by one or more multiplexing blocks, especially a data packet transmitted according to the real time transmission protocol, is used, each multiplexing block including the multiplexing block header and the load, wherein the multiplexing block header includes at least a start code and a position mark and may contain one or more of the following information: length information, type and fault tolerance information,

Wherein the length information of the multiplexing block is set based on the requirements of multimedia broadcast system configuration, when the length of the service data packet of mobile multimedia broadcast is less than the length of the load of the multiplexing block, one multiplexing block is used to carry the service data packet of mobile multimedia broadcast and the position mark of the multiplexing block is set as an end mark; when the length of the service data packet of mobile multimedia broadcast is larger than the length of the load of the multiplexing block, two or more multiplexing blocks are used to carry the service data packet of mobile multimedia broadcast and the position mark of the last multiplexing block is set as an end mark;

Step 2: the one or more multiplexing blocks are encapsulated into the corresponding video, audio or data unit according to the definition for the video, audio or data unit in the mobile multimedia broadcast standard,

For the video data packets of mobile multimedia broadcast using the real time transmission protocol, the video unit is formed by encapsulating one or more multiplexing blocks having the same time stamp and carrying the video data packets; for the audio data packets of mobile multimedia broadcast using the real time transmission protocol, the audio unit is formed by encapsulating one or more multiplexing blocks having the same time stamp and carrying the audio data packets; because there is no limitation for the time stamp, the data unit may be formed by encapsulating one multiplexing block;

Step 3: the video, audio or data unit is encapsulated into a multiplex sub-frame with the mobile multimedia broadcast standard multiplex-frame structure, a plurality of multiplex sub-frames are assembled into a multiplex-frame which is transmitted via a mobile multimedia broadcast network.

The receiving process of a receiver, which is an inverse process of the corresponding sending, comprises the following steps:

Step 1: a terminal receives a multiplex-frame from a physical channel according to the mobile multimedia broadcast multiplexing standard, resolves the multiplex-frame to obtain the video, audio or data section in the multiplex sub-frame, and further resolves the video, audio or data section to obtain the video, audio or data unit;

Step 2: the multiplexing block in the video, audio or data unit is resolved according to the definition of the multiplexing block described herein to obtain service data,

The step 2 further comprises positioning the multiplexing block using the start code of the multiplexing block and checking integrity of the multiplexing block in conjunction with the length of the multiplexing block and CRC, and especially when an error exists in the multiplexing block, positioning the next multiplexing block by searching the start code in order to avoid error extension, reduce data loss and improve transmission efficiency, incorporating the service data carried by the multiplexing block in connection with the position mark to obtain a large service data packet;

Step 3: the terminal utilizes the service data packet obtained by resolving the multiplexing block to realize upper layer application.

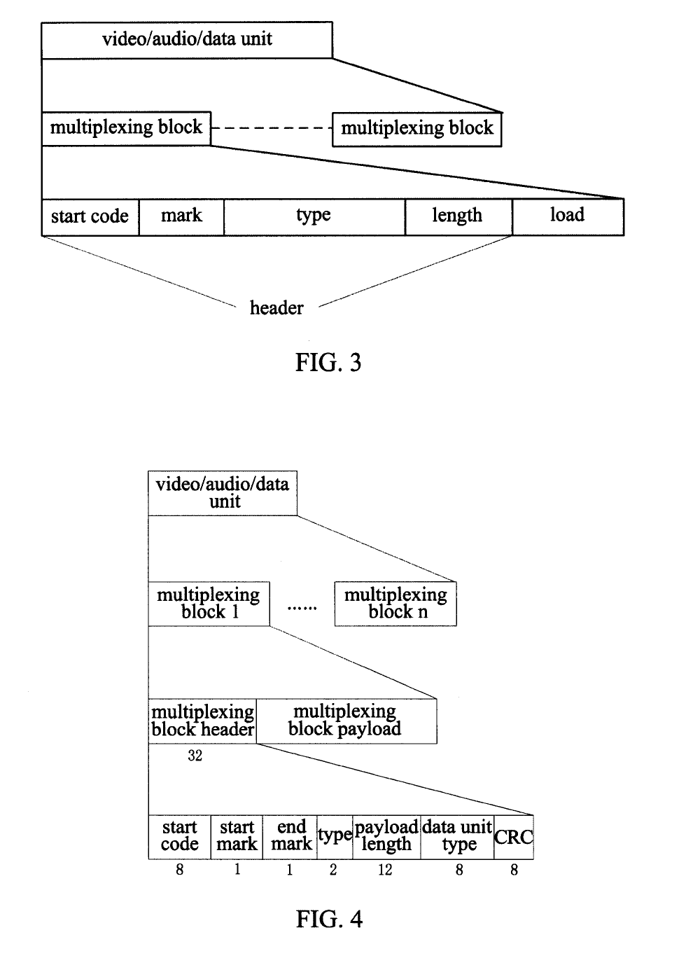

The structure scheme of the multiplexing block used by the method for transmitting mobile multimedia broadcast service data flow in the embodiment is illustrated in FIG. 3. The multiplexing block includes the header, which contains a start code, a position mark, length information, type and fault tolerance information, and the load. The fault tolerance information is omitted in this figure. Wherein:

The start code, which is used for identifying the beginning of the multiplexing block and is the first part of the header of the multiplexing block, may occupy the first byte or a plurality of bytes of the multiplexing block. In this embodiment, the start code taking a fixed value occupies 8 bits. In addition to being the beginning of the multiplexing block, the start code is a boundary of the multiplexing block in a video, audio and data unit for positioning and dividing the multiplexing block. Furthermore, when extracting the multiplexing block in the video, audio and data unit, a terminal may implement an integrity of the multiplexing block by checking the start code and the length.

The position mark, which is used when the mobile multimedia broadcast receives re-constructed service data packets, indicates whether the same service data packet is divided into one or a plurality of multiplexing blocks. When the service data packet is divided into the plurality of multiplexing blocks, the position mark also indicates whether the current multiplexing block is the first multiplexing block or the last multiplexing block constituting the same service data packet. In this case, the position mark is separated into a start mark describing the first multiplexing block and an end mark describing the last multiplexing block.

The length information means the load length of the multiplexing block taking a byte as a unit.

The type means a type of service data carried by the multiplexing block. In this embodiment, the type is used for distinguishing the multiplexing blocks obtained by segmenting an audio flow or a video flow from the multiplexing blocks obtained by segmenting a data flow.

The load means a load of the multiplexing block, i.e., the service data packet carried in the multiplexing block. In this embodiment, the load of the multiplexing block may be an audio or video data packet or a data packet.

The fault tolerance information is used when the terminal performs fault tolerance and checking on the service data packet carried by the multiplexing block. In this embodiment, CRC is used as the fault tolerance information.

FIG. 4 is a detailed usage situation of the embodiment.

A multiplexing block is composed of a multiplexing block header and multiplexing block payload. The multiplexing block header is composed of a start code, a start mark, an end mark, a payload length, a data unit type and a CRC. Wherein:

The start code with a fixed value of 0x55, which is an 8-bit field, identifies the first byte of the multiplexing block;

The start mark, which is a 1-bit field, identifies whether the current multiplexing block is the beginning of a video/audio/data unit. If it is the first multiplexing block of the video/audio/data unit, this position will be marked as 1; if not, this position will be marked as 0;

The end mark, which is a 1-bit field, identifies whether the current multiplexing block is the end of a video/audio/data unit. If it is the last multiplexing block of the video/audio/data unit, this position will be marked as 1; if not, this position will be marked as 0;

The type, which is a 2-bit field, is defined in the following table:

TABLE 1
The type of the multiplexing block

| mark bit | type |
|---|---|
| 00 | a multiplexing block carrying video |
| 01 | a multiplexing block carrying audio |
| 10 | a multiplexing block carrying data |
| 11 | reservation |

The payload length, which is a 12-bit field, identifies the payload length taking a byte as a unit;

The data unit type, which is an optional 8-bit field, is effective only when the type of the multiplexing block is “10”;

The CRC (Cyclic Redundancy Check), which is an 8-bit field, is the CRC for a multiplexing block header which contains no CRC.

The overhead of the multiplexing block includes the start code of 8 bits, the position mark of 2 bits, the type of 2 bits, the length information of 12 bits, the data unit type of 8 bits and the CRC of 8 bits, that is, at most 40 bits, and has higher efficiency for encapsulating and transmission compared with overhead of 96 bits of multi-protocol encapsulating in European Digital Video Broadcasting (DVB) standard.

In the embodiment, when the terminal resolves the video, audio or data unit, the error occurring in any of the multiplexing blocks will not affect other multiplexing blocks, thereby implementing error isolation. For the structure design of the multiplex-frame of mobile multimedia broadcast, the type of the multiplexing block presented in the embodiment ensures the high transmission efficiency and good fault tolerance of mobile multimedia broadcast systems.

### INDUSTRIAL APPLICABILITY

In the method in accordance with the present invention, a video, audio or data unit is formed by encapsulating one or more multiplexing blocks, each of which is isolated by a boundary of a start code, and an error occurring in any of the multiplexing blocks will not affect other multiplexing blocks, thereby implementing error isolation. In addition, the method allows a plurality of multiplexing blocks to transmit one multimedia service data packet through multiplexing block marks. The method further presents the type of the multiplexing blocks for the structure design of the multiplex-frame of mobile multimedia broadcast to ensure high transmission efficiency and good fault tolerance of mobile multimedia broadcast systems. In addition, in the method, the overhead for the header of the multiplexing block is small to ensure the performance of multimedia broadcast transmission.

1. A method for transmitting mobile multimedia broadcast service data flow comprises:
carrying a service data packet of a mobile multimedia broadcast system using one or more multiplexing blocks; and
encapsulating the one or more multiplexing blocks as a load into a video, audio or data unit of a mobile multimedia broadcast standard multiplex-frame corresponding to the service data packet, then encapsulating the video, audio or data unit into a multiplex sub-frame, and assembling a plurality of multiplex sub-frames into a multiplex-frame which is sent via a mobile multimedia broadcast network.

2. The method according to claim 1, wherein the multiplexing block comprises a header and a load, wherein the header comprises a start code used for identifying a beginning of the multiplexing block and a position mark used for indicating whether the current multiplexing block is a first multiplexing block or a last multiplexing block of the service data packet.

3. The method according to claim 2, wherein when a plurality of multiplexing blocks carry the service data packet of the mobile multimedia broadcast system, the position mark is separated into a start mark used for marking the first multiplexing block and an end mark used for marking the last multiplexing block.

4. The method according to claim 1, wherein the service data packet for mobile multimedia broadcast is transmitted according to a real time transmission protocol.

5. The method according to claim 1, wherein the multiplexing block further comprises one or more of the following information:
a type of the carried service data representing a type of service data flow carried by the multiplexing block;
load length information of the multiplexing block representing a length of the load of the multiplexing block; and
fault tolerance information, by which a terminal performs fault tolerance and checking of the service data packet carried by the multiplexing block.

6. A method for transmitting mobile multimedia broadcast service data flow comprises:
using, by a transmitter, one or more multiplexing blocks to carry a service data packet of a mobile multimedia broadcast system, encapsulating the one or more multiplexing blocks as a load into a video, audio or data unit of a mobile multimedia broadcast standard multiplex-frame corresponding to the service data packet, then encapsulating the video, audio or data unit into a multiplex sub-frame, and assembling a plurality of multiplex sub-frames into a multiplex-frame which is sent via a mobile multimedia broadcast network;
receiving, by a receiver, the multiplex-frame from a physical channel and resolving the multiplex-frame to obtain video, audio or data units, and resolving the multiplexing blocks in the video, audio or data units to obtain the service data packet; and
utilizing, by a terminal, the service data packet obtained by resolving the multiplexing blocks to realize upper layer application.

7. The method according to claim 6, wherein the multiplexing block comprises a header and a load, wherein the header comprises a start code used for identifying a beginning of the multiplexing block and a position mark used for indicating whether the current multiplexing block is a first multiplexing block or a last multiplexing block of the service data packet; and
after obtaining the multiplexing block by resolving, the terminal uses the start code of the multiplexing block to position the multiplexing block.

8. The method according to claim 7, wherein
when a plurality of multiplexing blocks carry the service data packet of the mobile multimedia broadcast system, the position mark is separated into a start mark used for marking the first multiplexing block and an end mark used for marking the last multiplexing block; and
after obtaining the multiplexing block by resolving, the terminal incorporates service data carried by the multiplexing block in connection with the position mark to obtain the service data packet.

9. The method according to claim 6, wherein,
the multiplexing block further comprises one or more of the following information: a type of the carried service data representing a type of the service data flow carried by the multiplexing block; load length information of the multiplexing block representing a length of the load of the multiplexing block; and fault tolerance information, by which the terminal performs fault tolerance and checking of the service data packet carried by the multiplexing block; and
after obtaining the multiplexing block by resolving, the terminal checks an integrity of the multiplexing block in conjunction with the load length information and the fault tolerance information of the multiplexing block.

10. A multiplex-frame for transmitting mobile multimedia broadcast service data flow, the multiplex-frame is composed of a plurality of multiplex sub-frames, each of which is used for carrying a video, audio or data unit, wherein
a load of said video, audio or data unit contains one or more multiplexing blocks used to carry a service data packet of a multimedia broadcast system, wherein each multiplexing block comprises a header and a load, the header comprises a start code used for identifying a beginning of the multiplexing block and a position mark used for indicating whether the current multiplexing block is a first multiplexing block or a last multiplexing block of the service data packet.

11. The multiplex-frame according to claim 10, wherein when a plurality of multiplexing blocks carry the service data packet of the mobile multimedia broadcast system, the position mark is separated into a start mark used for marking the first multiplexing block and an end mark used for marking the last multiplexing block.

12. The multiplex-frame according to claim 10, wherein the multiplexing block further comprises one or more of the following information:
a type of the carried service data representing a type of the service data carried by the multiplexing block;
load length information of the multiplexing block representing a length of the load of the multiplexing block; and
fault tolerance information, by which a terminal performs fault tolerance and checking of the service data packet carried by the multiplexing block.

13. The method according to claim 2, wherein the service data packet for mobile multimedia broadcast is transmitted according to a real time transmission protocol.

14. The method according to claim 2, wherein the multiplexing block further comprises one or more of the following information:
a type of the carried service data representing a type of service data flow carried by the multiplexing block;
load length information of the multiplexing block representing a length of the load of the multiplexing block; and
fault tolerance information, by which a terminal performs fault tolerance and checking of the service data packet carried by the multiplexing block.

15. The method according to claim 3, wherein the multiplexing block further comprises one or more of the following information:
a type of the carried service data representing a type of service data flow carried by the multiplexing block;
load length information of the multiplexing block representing a length of the load of the multiplexing block; and
fault tolerance information, by which a terminal performs fault tolerance and checking of the service data packet carried by the multiplexing block.

16. The method according to claim 7, wherein,
the multiplexing block further comprises one or more of the following information: a type of the carried service data representing a type of the service data flow carried by the multiplexing block; load length information of the multiplexing block representing a length of the load of the multiplexing block; and fault tolerance information, by which the terminal performs fault tolerance and checking of the service data packet carried by the multiplexing block; and
after obtaining the multiplexing block by resolving, the terminal checks an integrity of the multiplexing block in conjunction with the load length information and the fault tolerance information of the multiplexing block.

17. The method according to claim 8, wherein,
the multiplexing block further comprises one or more of the following information: a type of the carried service data representing a type of the service data flow carried by the multiplexing block; load length information of the multiplexing block representing a length of the load of the multiplexing block; and fault tolerance information, by which the terminal performs fault tolerance and checking of the service data packet carried by the multiplexing block; and
after obtaining the multiplexing block by resolving, the terminal checks an integrity of the multiplexing block in conjunction with the load length information and the fault tolerance information of the multiplexing block.

18. The multiplex-frame according to claim 11, wherein the multiplexing block further comprises one or more of the following information:
a type of the carried service data representing a type of the service data carried by the multiplexing block;
load length information of the multiplexing block representing a length of the load of the multiplexing block; and
fault tolerance information, by which a terminal performs fault tolerance and checking of the service data packet carried by the multiplexing block.
